(19) United States
(12) Patent Application Publication
(10) Pub. No.: US 2011/0158102 A1
(43) Pub. Date: Jun. 30, 2011

(54) METHOD AND SYSTEM FOR ROUTING DATA STREAMS IN AN IP NETWORK BY FLOODING OF A SUBSCRIBER SEARCH MESSAGE

(75) Inventors: Philippe Pombet, Suresnes (FR); Nicolas Auzou, Suresnes (FR); Simeon Wagner, Montreuil (FR)

(73) Assignee: THALES

(21) Appl. No.: 12/745,331

(22) PCT Filed: Nov. 28, 2008
(86) PCT No.: PCT/EP08/66440

§ 371 Date: Mar. 22, 2011

(30) Foreign Application Priority Data
Nov. 30, 2007 (FR) 0708394

(51) Int. Cl. H04L 12/26

(52) U.S. Cl. 370/238

(57) ABSTRACT

Method and system for determining the best path to be followed by a data stream within a communication network including several nodes communicating with one another through arteries. The method further includes an application QSAi executing the method steps, the location of the output gateway, the calculation of the routing cost, the instigation of a timeout proportional to the previously calculated cost, the setting up of the route between the caller and the called party, the preemption of resources, and the configuration of the router by imposition of the output port. The method further includes an input handler and an output handler, each linked to a router of the network. Each of the handlers includes a QSP application ensuring the conversion of the multimedia protocol into a protocol for routing in the network and a call and location server making it possible to steer the multimedia calls toward the QSP.

### CROSS REFERENCE TO RELATED APPLICATIONS

This application is the U.S. National Phase application under 35 U.S.C. §371 of International Application No. PCT/EP2008/066440, filed Nov. 28, 2008, and claims the benefit of French Patent Application No. 0708394, filed Nov. 30, 2007, all of which are incorporated by reference herein. The International Application was published on Jun. 4, 2009 as WO 2009/068650.

### FIELD OF THE INVENTION

The invention relates to a method of routing data streams in an IP network comprising, beforehand, a step of call broadcasting in the network by flooding of a subscriber search message.

### BACKGROUND

In order to respond to the needs expressed by a user or an application for transmitting data streams in a communication network comprising routing nodes and arteries, there currently exist various solutions which make it possible notably to find, for the user streams, the best path to be followed as a function, notably:
of the distance, number of hops to be traversed,
of the type of arteries to be followed, while avoiding satellite links, for example.

These solutions can also deal with problems of reserving necessary resources (bandwidth) on each artery of the path chosen to carry the communication and if need be, to preempt a communication of lower priority. The solutions, known by the Applicant, use for example:
Routing protocols of type such as: the “OSPF” (Open Shortest Path First) dynamic routing protocol, the “BGP” (Border Gateway Protocol) route exchange protocol, “OLSR” (Optimized Link State Routing Protocol) proactive routing protocol, to reach the destination the shortest way,
Protocols for reserving resources, for example of RSVP (Resource Reservation Protocol) type.

On the other hand, few prior art solutions simultaneously offer:
Routing which takes into account the QoS quality of service requested by an application and the state of occupancy of the arteries,
Preemption of lower priority communication in the case of saturation of the arteries.

Certain solutions known to the Applicant are constructed around the MPLS protocol (the acronym standing for “Multi Protocol Label Switching”) or else by an association of the aforementioned OLSR, RSVP protocols and marking of the route by policy routing. There also exist methods such as that described in the Applicant's patent application FR 07 02346.

Though these techniques are effective, they exhibit certain drawbacks however. For the MPLS technique, this technology considers only aggregated streams of the same type from the access sites, thereby making call-by-call QoS routing and communication-by-communication preemption of resources impossible.

For the solutions implementing OLSR, RSVP techniques, though these solutions globally afford the sought-after service, with a few provisos regarding preemption which is done although the called party has not yet responded or which can be triggered although another route exists, its major drawbacks occur at the level of the realization thereof:
The QSA agent as QoS agent hosts its own routing protocol and its own signaling protocol, without exploiting the routing protocol implemented by the standard routers of the network,
This routing protocol arises from a specific and therefore non-standard development.

In the case of the method set forth in patent application FR 07 02346, the solution requires an implementation of the routing service described in RFC 4915 (available on the http Internet link://www.ietf.org/rfc/rfc4915.txt) by the router, this not being the case for many off-the-shelf routers, and an adaptation of the RSVP protocol to accommodate multi-topological routing.

Moreover, in the aforementioned existing solutions, there is still the problem of the convergence time of the network routing tables. In certain cases of applications, for example in a tactical world, that is to say for networks whose topology may fluctuate greatly over time, certain communications may fail during this convergence phase.

Moreover, these solutions all use the RSVP standard reservation protocol in parallel with the call signaling. In most cases, the called party receives the call before the RSVP session is completely set up. Each direction determined for transmitting a data stream being negotiated separately, the paths may differ between the outward leg and the return leg, thereby complicating the processing to be done should there be a break in one of these paths.

In the subsequent description, the following abbreviations will be used to simplify the description:

QSA: designates an application charged with finding the best path as a function of a requested quality of service QoS, this application is superimposed on the protocol usually used by a router. It is carried out by a proprietary protocol based on flooding of the WAS network.
QSP: corresponds to a gateway whose function is to convert a call signaling of a communication into a signaling of a search for a better path in a network comprising several nodes,
LOC: subscribers location function,
LCC: call server function or “Local call control”.
Mr: subscriber search message
Mret: return Message

### SUMMARY OF THE INVENTION

The subject of the present invention relates to a method for determining the best path followed by a data stream within a communication network comprising several nodes consisting of a router associated with an application, communicating with one another through arteries, an input gateway and an output gateway ensuring the conversion of the multimedia protocol into a protocol for routing in the network characterized in that in an embodiment, it comprises at least the following steps:
receiving a call setup request from a subscriber A seeking to contact a subscriber B,
locating the called party B at the level of a call server and identifying the output gateway to be reached on the network,
converting the call location of said request into better-path search signaling by introducing the quality of service required by the communication into a subscriber search message Mr,
flooding the entirety of the nodes of the network by broadcasting the subscriber search message Mr emitted by the input gateway toward said nodes up to the output gateway,
at the level of each of the nodes and on receipt of the subscriber search message Mr, determining for each node, the cost of the artery through which the subscriber search message arrived, reserving the requested resource and instigating a waiting timeout τi proportional to the cost of the artery, before retransmitting the subscriber search message on the other arteries adjacent to said node except for the artery through which the message Mr arrived,
on receipt of the first subscriber search message Mr on the output gateway, emitting a return message Mr traversing the reverse path to that by which the first search message arrived, that is to say the optimal path P determined by the mechanisms of timeout executed at the level of each of the nodes of the network.

According to an embodiment, if a node receives through an artery an already processed subscriber search message, then, it ignores said message.

On receipt of the return message Mret, at the level of the input gateway, then the communication is, for example, set up by transmitting the call parameters to the output gateway.

The confirmation of setup of the communication between the caller A and the called party B is transmitted through the network and on receipt of this confirmation, each of the nodes performs a preemption and for each direction of flow of a message executes a routing policy command to impose an output port on the router.

The data can be multimedia communications.

The invention also relates to a system making it possible to determine the best path to be followed by a data stream within a communication network comprising several nodes communicating with one another through arteries, and constituting a communication network characterized in that in an embodiment it comprises at least the following elements:
at the level of each router of the network an application QSAi executing the steps of the method described above and performing the location of the output gateway, the calculation of the routing cost, the instigation of a timeout proportional to the previously calculated cost, the setting up of the route between the caller and the called party, the preemption of resources and the configuration of the router by imposition of the output port for this communication,
an input handler and an output handler, each linked to a router of the network, each of the handlers comprising a QSP application ensuring the conversion of the multimedia protocol into a protocol for routing in the network and a call and location server making it possible to steer the multimedia calls toward the QSP.

### BRIEF DESCRIPTION OF FIGURES

Other characteristics and advantages of the present invention will be more apparent on reading the description which follows of an exemplary embodiment given by way of wholly nonlimiting illustration, accompanied by the figures which represent:

FIG. 1, an exemplary general architecture of a system according to the invention,

FIG. 2, the phase of searching for a subscriber,

FIG. 3, the phase of setting up the communication, and

FIG. 4, the communication once set up.

### DETAILED DESCRIPTION

In order to better elucidate the principle implemented in the invention, the description which follows is given by way of wholly nonlimiting illustration within the framework of a multimedia call through an IP tactical wide area network more generally known by the acronym “WAS IP” for Wide Area System IP (Internet Protocol). The invention can also be used in systems of WAN (Wide Area Network) type.

The method according to the invention can, however, be applied in any network supporting the IP protocol (high-throughput radio networks or tactical network). It applies notably for Multimedia services which require reservation of resources.

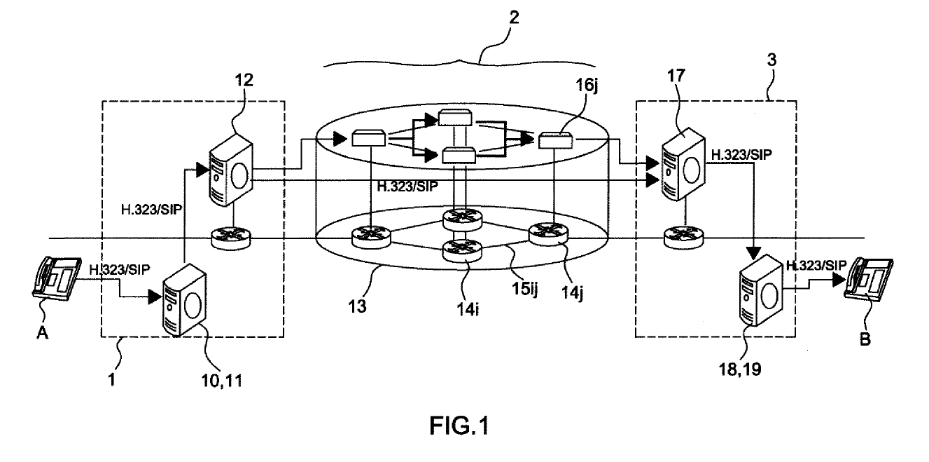

FIG. 1 represents an exemplary structure allowing the implementation of the method according to the invention, comprising for example a first handler 1, comprising means allowing the setup of a call from a subscriber A seeking to contact a subscriber B, for example. This handler comprises a call server 10 or LCC for Local Control Call, a location server 11 or LOC, the function of these two servers being to steer the multimedia calls to a gateway 12 more commonly called a Proxy-QSP QoS which makes it possible notably to convert a call signaling of a communication from subscriber A into better-path search signaling.

It is possible to use all the protocols known by the Person skilled in the art under the designation H.323, for example.

The system comprises a second part 2, linked to the gateway 12 and charged with implementing a flooding-based routing method explained further on in the description. This second part comprises an IP network 13 composed of several linked nodes 14i communicating with one another through arteries 15ij, this network serving for the transport of the data. The network 13 supports, for example, an IP routing protocol. On this network is positioned the flooding-based routing method according to the invention, represented by the applications 16i which are each associated with a router 14i. The flooding-based routing method is thus positioned above the WAS IP routing.

A third part 3 allows the reception of the call from subscriber A and the connection of subscriber B (setup of a communication between A and B). A gateway 17 is linked to the network 13, the gateway 17 has a similar function to the gateway 12. This gateway 17 is linked with a call server 18 or LCC for Local Control Call, a location server 19 or LOC, the function of these two servers being to steer the multimedia calls.

The system being symmetric, the input gateway 12 can also play the role of output gateway, while the output gateway 17, that of input.

In the example given, the Voice-over-IP signaling designated by the abbreviation VoIP will be conveyed with the signaling associated with the WAS routing.

At the level of each of the routers 14i of the transit network 13 is added an application QSAi having the function of finding the best path in the network as a function, notably, of the quality of service QoS required by the application, and of the state of occupancy of the arteries and of activating policy routing commands or PBR, the abbreviation standing for Policy Based Routing, so as to impose the best path found on the associated router, with respect to that which would have been obtained by the conventional routing protocols.

The routers 14i can be routers of COTS type (components off the shelf) and can implement IGP (Interior Gateway Protocol) routing protocols. Above this protocol, the application QSAi is implemented at the level of each of the routers or nodes of the network, so as to determine the location of an output point of the WAS, the routing cost, the setup of the route offering the best cost, the preemption of resources and to ensure the configuration of the router.

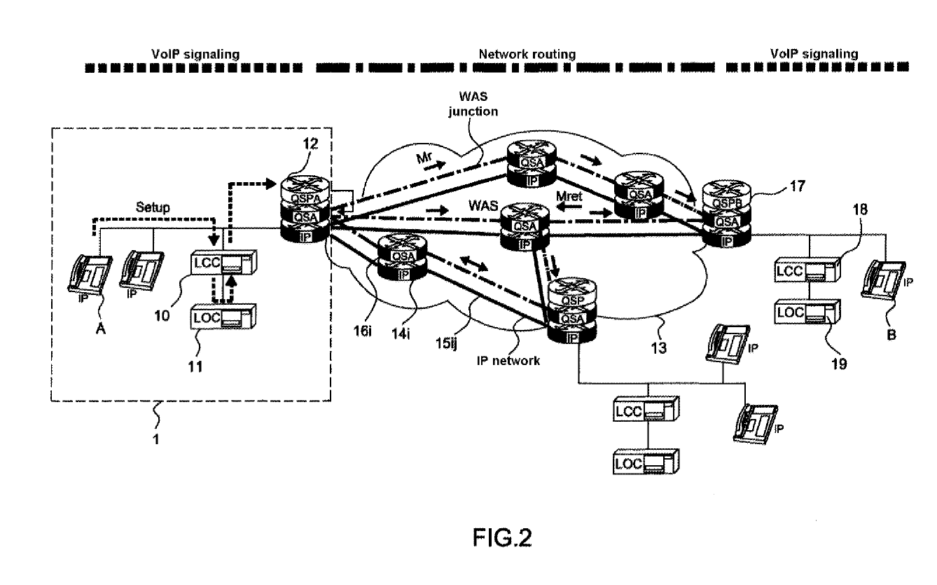

The method according to the invention described in relation to FIGS. 2, 3 and 4 comprises the following steps:

FIG. 2 shows diagrammatically the phase of searching for a subscriber.

The setup of a multimedia call through a WAS IP between the two handlers 1 and 2 is performed in accordance with the process below:

When a call (Setup) reaches the call server 10 of the handler 1, it turns to the location server 11 to obtain the location of the called party B (and the next hop to be performed to reach it) and identify the output gateway to be reached. In the case of a multimedia service, the function LOC gives the coordinates: of the LCC server 18 (server on which the called party B is registered) to be reached and, if a network of WAS type has to be crossed, of the two access gateways to this WAS. In the example of FIG. 2, the LCC server to be reached is the server 18 and the gateways are the gateways 12 and 17, respectively so that the caller A can reach the called party B.

The setup (modified) is then prolonged to the local QSP (in the figure the QSPA corresponding to subscriber A) which instigates the broadcasting (by flooding) of the subscriber search to the QSAi of the WAS network or wide area network 13, specifying the throughput and the priority of the communication. The throughput and priority parameters are introduced into the subscriber search message on the basis of the data provided in the setup.

The setup message also specifies the type of service requested (video, audio, etc.). The setup is kept on standby in the handler 1.

The subscriber search or the subscriber search message is thus broadcast gradually throughout the WAS network 13. The various applications QSAi which each drive the routers 14i of the network 13, search for the best path, doing so until reaching the output gateway 17 (and up to the QSPs).

For this purpose, on receipt of the search message Mr, each QSAi calculates the cost of the artery 15ij through which the message arrived. This cost takes into account:
the state of occupancy of the arteries followed in terms of throughput and number of communications,
the number of preemptions optionally to be undertaken,
the media used to penalize the arteries with high latency, jitter or error rate, optionally the security level of the artery.

Thereafter, each QSAi instigates a waiting timeout τi proportional to the cost determined for the artery 15e, the artery through which the message arrived, before retransmitting the subscriber search message Mr on all the other adjacent arteries, except for the artery 15e through which the subscriber search message arrived. If the QSAi receives through another artery, an already processed search message, it no longer processes this search message.

On receipt of the search message, a QSAi will carry out a reservation of resources as a function of the throughput recorded in the subscriber search message.

On the first receipt at the output gateway 17 of the subscriber search message, a return message Mret emitted by the QSP function of the handler of the called party B traverses in the reverse direction the optimal path P found by the mechanism of the successive timeouts τi implemented within the various QSAi of the network. Each of the nodes 16i knows the input arteries 15e of the first arrived subscriber search message. Subsequent receipts of the search messages originating from other nodes of the network are ignored by the gateway 17.

On completion of this second phase, the optimal path P is determined and the phase of setting up the communication can be engaged.

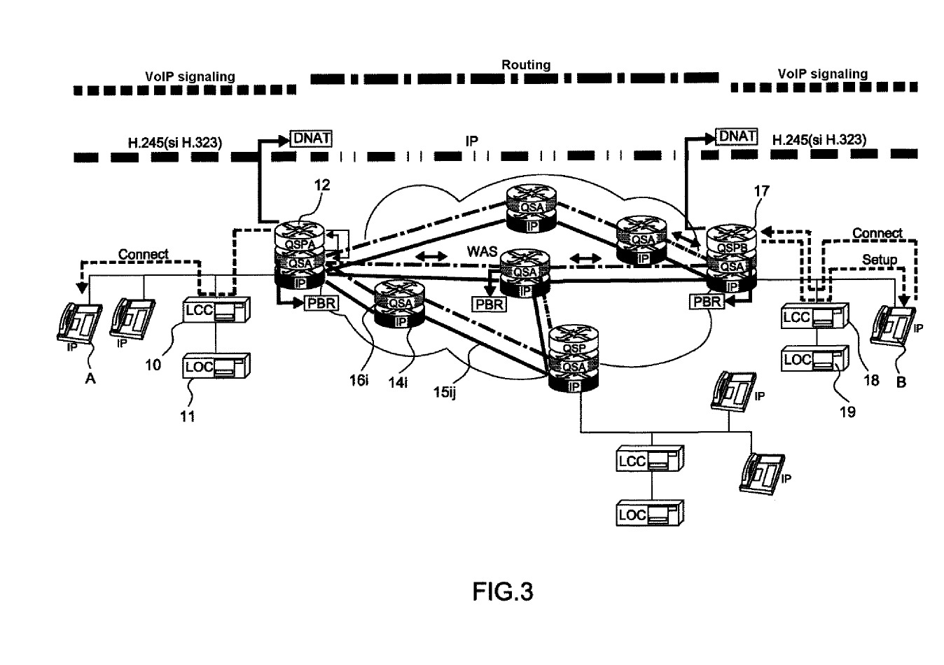

FIG. 3 represents the phase of setting up the communication.

Once subscriber B has been found, the transmission of the message from A to B is performed in the following manner:
at the level of the calling QSP_{A}, therefore the gateway 12, on receipt of the return message Mret, the setup of the communication (also transporting the initial call message so that the called QSP_{B} 17 for subscriber B can regenerate the call in his handler 3) is emitted on the optimal path P found,
the called QSP_{B} 17 recovers the call message and transmits it to the LCC call server 18 of his handler 3,
when the called party B picks up, a call setup confirmation is conveyed in the WAS, which confirmation is transported by the various applications 16i,
on receipt of the call confirmation, each application QSAi crossed optionally performs a preemption (if communications of lower priority have to be released to recover resources for the communication in progress), and then, for each direction of transmission, each application QSAi executes a policy routing command (PBR) to impose an output port 20k on the local router 14i for a given pair (IP_{QSP}, RTP/RTCP Port). The QSA and QSP applications parameterize the routers 14i, so that the media stream follows a path which does not necessarily correspond to that defined by the router's routing protocol. An application QSAi will thus determine the switchings within the router toward designated output arteries to carry the traffic corresponding to the IP addresses and ports of the two QSPs.
The setup confirmation is translated into a “Connect” message of the Voice-over-IP “VoIP” protocol used by the QSP of the caller A.

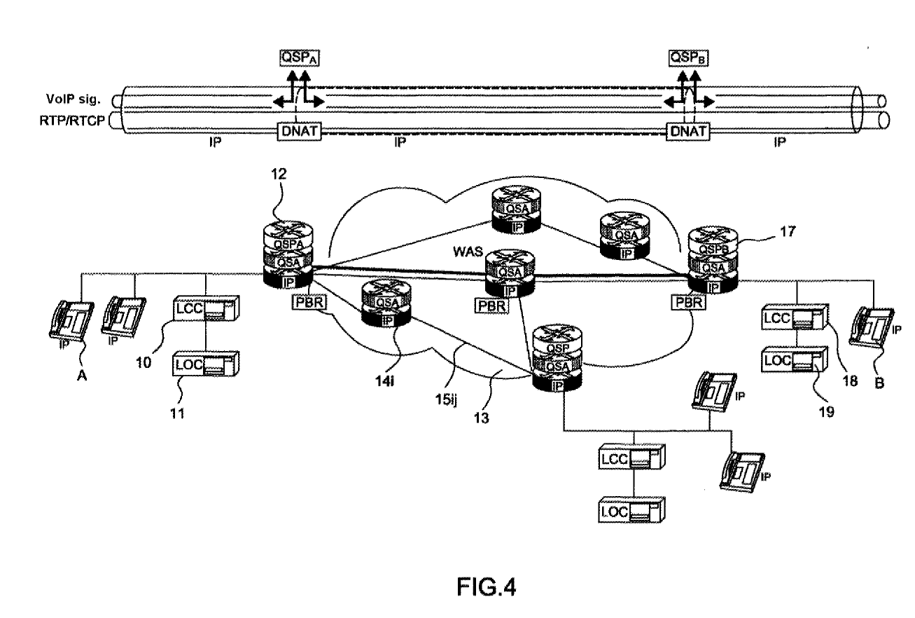

In the two handlers 1 and 2, at the end of the negotiations relating to the logic ports and to the CODECs (coder decoder), DNAT commands are emitted by the QSPs so that the access routers replace on the fly the IP addresses of the terminals with those of the QSPs for the (RTP/RTCP) media streams. Thus, it is not necessary to wait for the negotiation of the addresses/ports between terminals in order to establish the path in the transit network. In FIG. 4 has been represented the path followed by the messages, once the communication has been set up.

The DNAT and PBR commands performed on the routers make it possible for the media streams not to travel through the QSP and QSA servers, thus guaranteeing optimal performance. The path from the media standpoint is indicated in FIG. 4.

Physically, an application QSAi is installed, for example:
either in a specific item of equipment connected to the router 14i by an Ethernet link (or Serial link),
or, if the routers so allow (Linux, CISCO), integrated into the router in the guise of complementary application.

The method according to the invention offers notably one or more of the following advantages:
it manages the resources in a symmetric manner call by call,
it performs the preemptions when the called party has responded and if there really is no other possible path. Moreover, the method relies on any IGP routing used in the transit network,
it does not depend on routing functionalities that have not yet been industrialized by the manufacturers of routers,
it is implemented above the IP protocol, thus making it possible to vary the costs of the arteries while the communications are being set up and released without impacting the routing nodes to which the communication in progress is of no relevance.

It exhibits the advantage of being able to be used in all networks exhibiting high topological mobility and arteries with low throughput, for example for tactical networks over IP, high throughput radio networks, etc.

1. A method for determining the best path followed by a data stream within a communication network comprising several nodes consisting of a router associated with an application, communicating with one another through arteries, an input gateway and an output gateway ensuring the conversion of the multimedia protocol into a protocol for routing in the network comprising:
receiving a call setup request from a subscriber A seeking to contact a subscriber B,
locating the called party B at the level of a call server and identifying the output gateway to be reached on the network,
converting the call location of said request into better-path search signaling by introducing the quality of service required by the communication into a subscriber search message Mr,
flooding the entirety of the nodes of the network by broadcasting the subscriber search message Mr emitted by the input gateway toward said nodes up to the output gateway,
at the level of each of the nodes and on receipt of the subscriber search message Mr, determining for each node, the cost of the artery through which the subscriber search message arrived, reserving the requested resource and instigating a waiting timeout τi proportional to the cost of the artery, before retransmitting the subscriber search message on the other arteries adjacent to said node except for the artery through which the message Mr arrived,
on receipt of the first subscriber search message Mr on the output gateway, emitting a return message Mr traversing the reverse path to that by which the first search message arrived, which is the optimal path P determined by the mechanisms of timeout executed at the level of each of the nodes of the network.

2. The method as claimed in claim 1, further comprising the steps of ignoring an already processed subscriber search message when a node has already received the message through an artery.

3. The method as claimed in claim 1, further comprising the steps of setting up the communication by transmitting the call parameters to the output gateway upon receipt of the return message Mret, at the level of the input gateway.

4. The method as claimed in claim 2, wherein the confirmation of setup of the communication between the caller A and the called party B is transmitted through the network that on receipt of this confirmation, each of the nodes performs a preemption and for each direction of flow of a message executes a routing policy command to impose an output port on the router.

5. The method as claimed claim 1 wherein the data include multimedia communications.

6. A system making it possible to determine the best path to be followed by a data stream within a communication network comprising several nodes communicating with one another through arteries, and constituting a communication network comprising at least the following elements:
at the level of each router of the network an application QSAi executing the steps of the method as claimed in claim 5 and performing the location of the output gateway, the calculation of the routing cost, the instigation of a timeout proportional to the previously calculated cost, the setting up of the route between the caller and the called party, the preemption of resources and the configuration of the router by imposition of the output port for this communication,
an input handler and an output handler, each linked to a router of the network, each of the handlers comprising a QSP application ensuring the conversion of the multimedia protocol into a protocol for routing in the network and a call and location server making it possible to steer the multimedia calls toward the QSP.
